(19) United States
(12) Patent Application Publication
(10) Pub. No.: US 2026/0262085 A1
(43) Pub. Date: Sep. 3, 2026

(54) METHODS, COMMUNICATIONS DEVICES, AND INFRASTRUCTURE EQUIPMENT

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/995,843

(22) PCT Filed: Jun. 30, 2023
(86) PCT No.: PCT/EP2023/068047

§ 371 Date: Jan. 17, 2025

(30) Foreign Application Priority Data
Jul. 28, 2022 (EP) 22187615.4

(51) Int. Cl. H04W 74/0816; H04B 17/309; H04W 8/22

(52) U.S. Cl. CPC H04W 74/0816; H04B 17/346; H04W 8/22

(57) ABSTRACT

Methods, communications devices, infrastructure equipment and circuitry for requesting coordinated sensing between sensors or communication devices. A communication device determines to send a request to participate in coordinated sensing to one or more other communications devices and transmits the request to participate in coordinated sensing to the one or more other communications devices. Another communications device or an infrastructure equipment receive the request to participate in coordinated sensing and determine whether to participate in coordinated sensing with the other communications device.

The present application claims the Paris Convention priority of European patent application EP 22187615.4, filed 28 Jul. 2022, the contents of which are hereby incorporated by reference.

### BACKGROUND

### Field of Disclosure

The present disclosure relates to communications devices, infrastructure equipment and methods for coordinated sensing between communications devices in a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is extended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

With the expected increase in VR and XR services, and particularly with the anticipated rise in deployments of technology in areas such as Vehicle-to-X, V2X, it is anticipated that coordinated sensing will be necessary, and will increasingly be made possible by the development of the Internet of Things, IoT, and MTC devices.

### SUMMARY OF THE DISCLOSURE

The present disclosure can help address or mitigate at least some of the issues discussed above.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure.

FIG. 2 schematically represents some aspects of a new radio access technology (RAT) wireless telecommunications system which may be configured to operate in accordance with certain embodiments of the present disclosure.

FIG. 3 is a schematic block diagram of an example infrastructure equipment and communications device which may be configured to operate in accordance with certain embodiments of the present disclosure.

FIG. 4 represents a message flow diagram between two peer communications devices which may be adapted in accordance with certain examples of the present disclosure.

FIG. 5 represents a message flow diagram between a communications device and an infrastructure equipment that may be adapted in accordance with certain examples of the present disclosure.

FIG. 6 illustrates an example scenario for requesting coordinated sensing between communication devices according to an example of the present disclosure.

FIGS. 7A-C illustrate methods for requesting and implementing coordinated sensing according examples of the present disclosure.

### DETAILED DESCRIPTION OF THE EMBODIMENTS

### Long Term Evolution Advanced Radio Access Technology (4G)

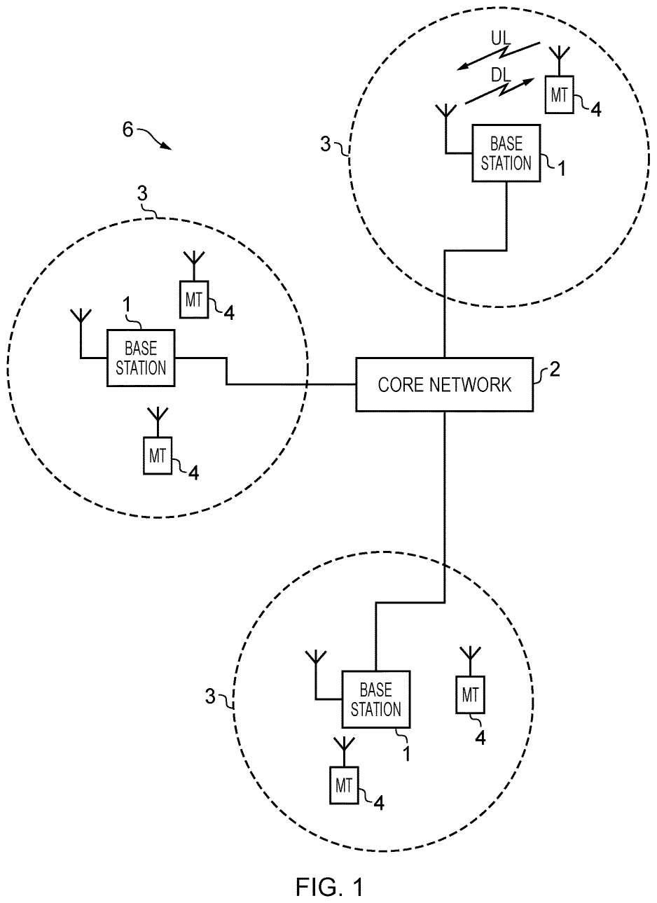

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality.

However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1 10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

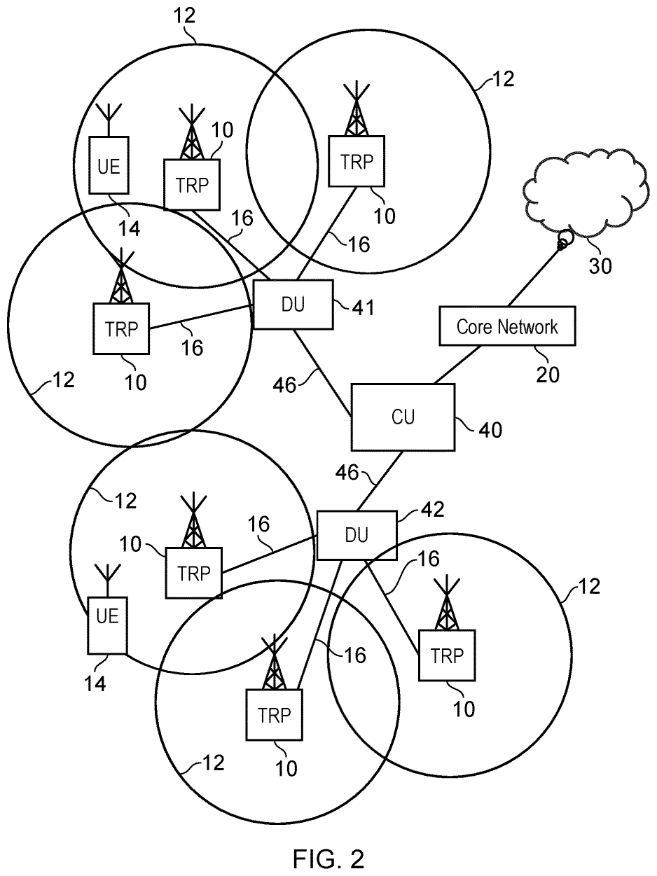

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

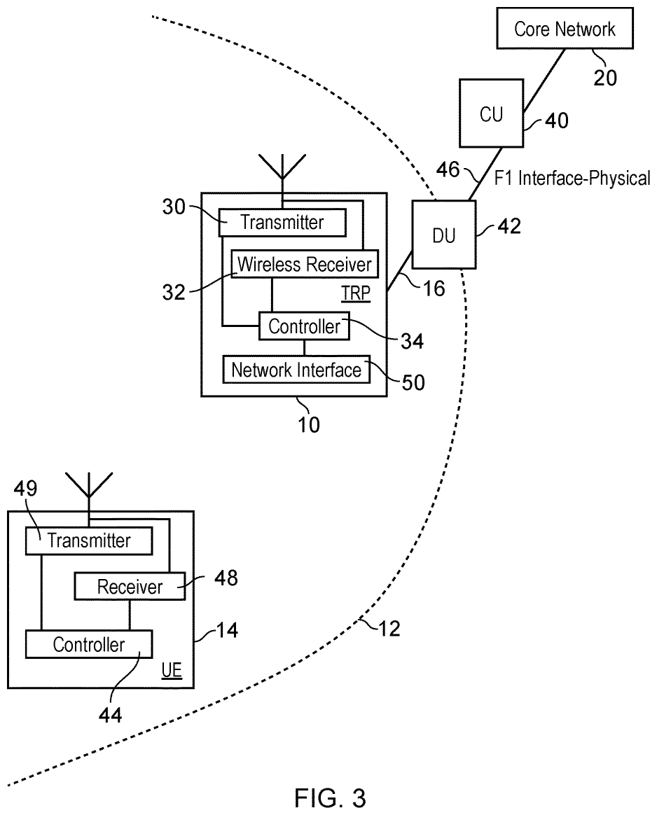

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Integrated Sensing and Communication

Recent areas of interest in this field relate to integrated sensing and communication [3], particularly wireless sensing and the applications that this may have in future technology with respect to vehicles and vehicle-based technology systems.

Wireless sensing is the acquisition of information related to a remote object and its characteristics without any physical contact with the object itself. Data relating to the perception of the object and its surroundings may be analysed by a communications device, and characteristics of the object may be determined from this analysis process. For example, a common form of wireless sensing is radar, which may use radio waves to determine at least the distance to, angle of, and/or instantaneous velocity of, a remote object without any physical contact between the object and a sensing device such as a radar gun. Other radio-frequency, RF, sensing techniques are available, in addition to non-RF sensing techniques such as time-of-flight cameras, accelerometers, gyroscopes, and Lidar.

Integrated sensing and communication includes at least two scenarios, which can be broadly divided into communication assisted sensing and sensing assisted communication. Communication assisted sensing may be thought of e.g. as a communication system, and the operation thereof, providing sensing services. Sensing assisted communication may be thought of, e.g. as when sensing information related to a communication channel or environment is used to improve a communication service of a communication system itself. For example, sensing information may be used to assist radio resource management, interference mitigation, beam management, mobility etc. of a communications system such as a 5G wireless communications network.

With regard to the first of these scenarios, communication assisted sensing, there are a number of services where this technology might be employed. One example of these include real-time monitoring of the environment of a communication system. That is to say, wireless signals may be used to reconstruct a local environment map, with the aim of further improving positioning accuracy and enabling environment related applications. Such environment related applications may include the creation and maintenance of a dynamic 3D map for driving assistance, pedestrian flow statistics, intrusion detection, etc. Another example may include the application of communication assisted sensing to autonomous vehicles or unmanned aerial vehicles, which, although different, have some common functional requirements and so have been amalgamated here for the sake of brevity. For example, both autonomous vehicles and UAVs may support Detect and Avoid, DAA, procedures to avoid obstacles and collisions. Furthermore, both may have capability for monitoring path information, such as traffic monitoring, selection of routes, complying with traffic regulations etc.

Another example of using communication assisted sensing would be the monitoring of air pollution. The quality of a received wireless signal displays different attenuation characteristics and coefficients as a function of air humidity, air particulate matter, PM, concentration, carrier frequency, etc. It is anticipated that this may be used for weather and air quality monitoring and detection. A final example related to communication assisted sensing is the application of this technology to indoor healthcare and intrusion detection. A number of medical and healthcare objectives may be achieved using this technology, such as estimation of respiration rate, estimation of breathing depth, apnoea detection, monitoring of vital signs of elders and infants, and indoor intrusion detection.

Sensing assisted communication also has a number of potential applications, and the sensing of wireless communication channels and the surrounding environment could further improve the performance of communication systems. Some examples of sensing assisted communications include narrowing a beam sweeping range and shortening a beam training time as a result of sensing a user equipment/communications device's location and channel environment. This may have benefits of reducing a time required to establish a connection between a communications device and a wireless communications network, and thus reduce both interference of signals on a wireless access interface and power consumption. Another application relates to prediction. Through sensing a communications device's location, velocity, motion trajectory and channel environment, either as a standalone procedure or as part of a beamforming process described above, overheads of communications related to beam measurement and the delay of beam tracking may be reduced. Furthermore, sensing of a communications device's properties and channel environment may allow improvements with respect to a channel estimation for communication between the communications device and the wireless access network.

Coordinated sensing operations enable sensors to collaborate and exchange sensing information, with the aim to improve sensing reliability and quality [4]. However, to support this future development, a number of requirements may be necessary. For example, in an automotive use case, the 5G system may need to support functionalities enabling collaborative communication and sensing, including communications devices supporting NR-based sensing capabilities or other non-NR based sensors. They may be required to collaborate with the network and/or with other communications devices in this.

The system employing this coordinated sensing operation may be required to assist communications devices with sensing capabilities in discovery and coordination processes, and may provide authorization and configuration to a communications device to establish a communication connection for sensing collaboration. This may include particular processes related to when the communications device is located in specific geographical areas, or when other predetermined conditions are met, in which the sensing operation is required or allowed. This communication connection used for sensing collaboration may include direct communication with other vehicles, communication with 5G systems via base station(s), or with relay device(s).

Furthermore, various authorized 3^{rd} parties may have access via the communications network system to the communications devices' sensing data, capabilities, and configuration. In some examples, this may be to facilitate 3^{rd} party control and coordination of sensing inputs from one or more sensing communications device.

Within this context, various examples of the present disclosure address the problem of supporting communication assisted sensing, particularly as it relates to coordinated sensing and the sharing of related data between communications devices. To address the overarching problem, a number of stages are necessary, such as, for example, the discovery of sensing capability, establishment of a sensing based connection, a sensing based service request, and the creation of a group for coordinated sensing. As would be apparent to the skilled person, in some scenarios, elements of the above process are not necessary, and may be omitted, e.g. forming a group for coordinated sensing, and elements not disclosed above may be necessary, and may be performed in line with the technical knowledge that the skilled person possesses. Furthermore, the elements of the process outlined above may be performed in an order different to that outlined, such as for instance the service request and connection establishment taking place in a single step. In particular, the present disclosure relates to the first of the above steps, that of a sensing capability discovery procedure.

### Sensing Capability Discovery

In order to enable the efficient sharing of sensing capability between communications devices, it may be necessary to discover and/or share the sensing capability of sensors between communications devices. These other sensors may be other communications devices, or a central unit, such as an infrastructure equipment (e.g. a gNB), road-side unit (RSU), or relay node, where the central unit may relay its own sensing capabilities or that of communications devices connected to the central unit, in some examples and in keeping with certain conditions such as privacy policies.

Information related to these sensors may also be shared, such as a technology that the sensing capability is based on, an accuracy of the sensing capability, a range of the sensing capability, whether the sensor is able to be coordinated or not, and other relevant information. Example information related to sensing capability for an example radar sensor may include
Type of sensor (e.g. mmWave radar 24 GHz, 79 GHz)
A range of the sensor (distance e.g. short range, medium range, long range)
Detectable range (angle e.g. wide angle, narrow angle)
Accuracy/resolution (range, velocity e.g. 50 cm range resolution)
Type of output data (raw data, processed data, meta data)
Type of activation (always on, occasionally on, on-demand)
Policy of data sharing (allowed, not allowed due to privacy policy)
Cost of sensor activation (power consumption e.g. battery operation)

Sensing capability may be based on a Device-to-Device, D2D mode (where, for example, sensor A and sensor B exchange sensing capability information) or it may be based on a central mode (sensors may send sensing capability request to a central unit e.g. relay node, RSU, or base station). Users may be able to control a policy of data sharing from the sensor. For example, a user may not want to share data from the sensor (e.g. video data, location information etc.) because of privacy concerns and for privacy protection. Therefore, in this case, the sensor may not be permitted to share data with another sensor or with the central unit, except for in a predetermined set of situations such as an emergency situation like a traffic accident, or to comply with legal requirements, or if involved in a criminal case.

Some sensors may usually be in a power-off mode in order to minimise power consumption, and may be activated only when required to make readings. For example, GNSS in a communications device typically consumes a large amount of power, relative to the other functions of the communications device. In this case, GNSS may only be activated when an accurate position of the communications device is required; it may be in the power-off mode when not required. On the other hand, for example, a sensor in a car may always be active while the engine of the car is running. Therefore, it may be important to be aware of a cost of sensor activation in addition to hardware capability.

It is anticipated that in certain examples of the present disclosure, the capability can be contained in a container in order to support forward capability development, that is, to support the integration of future sensors with new capability. The container allows for the future introduction of new sensors and corresponding capabilities. Based on sensing capability discovery, a communications device can determine with whom: it is going to connect in order to exchange sensing information, it is going to collaborate in order to perform coordinated sensing e.g. transmission parameters adjustment; and/or it is going to ask a central unit to request/assist coordinated sensing.

In a first example, signalling for sensing capability discovery may be performed in a device-to-device, or D2D, mode. In this example, a communications device communicates directly with another communications device, or sensor, and determines through the exchange of signals representing data and information whether sensing information may be shared, along with relevant information related to this sensing information. The transmission of signals disclosed here may be based on a broadcast or unicast method of transmission.

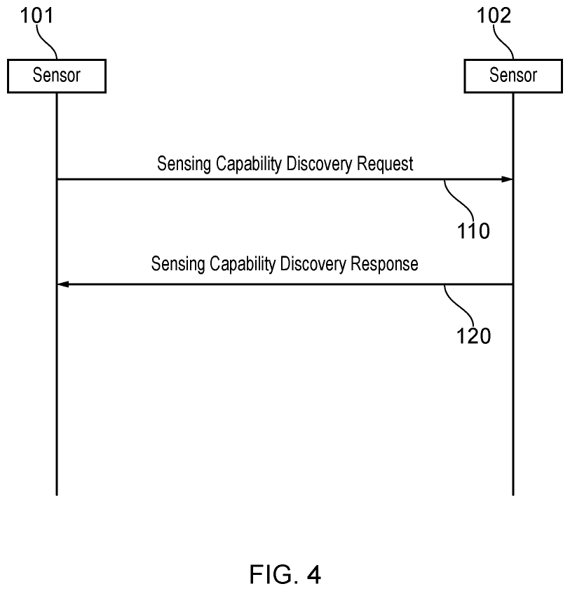

This example is shown graphically in FIG. 4. FIG. 4 shows a message flow diagram between a requesting communications device represented by Sensor 101 and a recipient communications device represented by Sensor 102. In a first step, the requesting communications device 101 sends a transmission 110 to the recipient communications device 102, which is a sensing capability discovery request. This request may, for example, request certain categories of sensing information from the recipient communications device, such as wide-angle radar data of a particular location in keeping with the example information categories outlined above.

The transmission 110 may be a broadcast transmission, in which case a broadcast message will be transmitted to trigger the process of sensing capability discovery. The broadcast transmissions may be receivable by one or more recipient communications devices 102. This message may be a D2D discovery message, or a newly defined sensing capability discovery message, and may include the requested sensing capabilities such as a sensing technology, sensing accuracy, sensing range, or if the sensor is able to coordinate or not. This discovery message 110 may be transmitted periodically or on demand. If the transmission is performed on demand, an indication will be included in the transmission 110 to indicate that the message is for sensing capability discovery in an initial request message. The sensors that receive this initial request message may broadcast in response their sensing capability in a sensing capability discovery message 120. This broadcasted sensing capability discovery response message 120 may also apply to transmission to a base station, a RSU, and a relay node as well as to other communications devices. For instance, if a base station has sensing capabilities, it can include, in the sensing capability discovery response message, information related to its sensing capabilities as on demand system information or as always on system information.

The above discussion, which relates to a broadcast mode of transmission of discovery request messages 110 can be extended to a groupcast mode. In this mode, a transmission 110 is transmitted to a group of receiving entities, which may include, for example, communications devices 102, base stations, road side units and/or relay nodes, and of which the requesting communications device 101 or sensor is a part. The message may be sent only within a group of which the requesting communications device 101 is already a part.

Alternatively, to a broadcast or groupcast mode, the communications device 101 may transmit signals requesting sensing capability discovery in a unicast mode. In this unicast mode the communications device 101 transmits a unicast request 110 to a single recipient, rather than a plurality of recipients as in the above mode, however, it will be appreciated that multiple unicast requests may be transmitted, each to a different recipient. Unicast mode may apply only to D2D communications devices that have established a PC5 connection with the recipient, or have a pre-existing remote UE-relay UE connection with the recipient. A sensing capability discovery request message 110 may be transmitted from one communications device 101 to another communications device 102 with which it has a PC5 connection.

In response to the sensing capability discovery request 110, the recipient communications device 102 may respond with a sensing capability discovery response 120 to provide an indication of the sensing capability that it can provide, in a unicast or broadcast mode. In some embodiments the recipient communications device 102 may provide an indication of which categories of data it can provide to the requesting communications device 101, or it may provide a single indication of whether it is able to fulfil the request of the requesting communications device 101. This transmission 120 is sent from the recipient communications device 102 to the requesting communications device 101. In response, the recipient of the request message 102 may transmit a reply message to the communications device 101. These messages may be transmitted in the form of a PC5 RRC signalling message, or in the form of user plane data. After receiving the response 120, the requesting communications device 101 may subsequently request sensing capability from other communications devices, although this is not shown in FIG. 4.

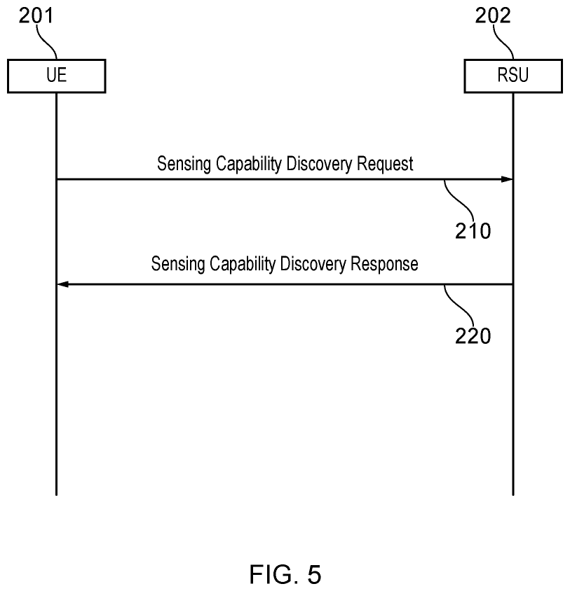

In a second example, signalling for sensing capability discovery may be performed in a central mode. In this central mode, the communications device communicates with a central unit, such as an infrastructure equipment forming part of the wireless communications network, in order to obtain sensing information. This is seen graphically in FIG. 5, which shows a message flow diagram between a communications device, represented as UE 201, and an infrastructure equipment, or central unit, connected to a wireless communications network, represented by RSU 202, however it should be appreciated that in the foregoing discussion the central unit may for example be a base station or a relay node or a RSU instead. Furthermore, it should be appreciated that, within the present disclosure, the term ‘communications device’ may refer to at least a user equipment or a sensor, as illustrated in FIGS. 4 and 5.

In a first step, the communications device 201 transmits to the central unit 202 a transmission of signals 210 representing a sensing capability discovery request. This request may be for sensing capability of the central unit 202 itself, or of sensing capability of other communications devices that report their sensing capability to the wireless communications network. For example, the communications device or sensor 201 may transmit a request to a central unit 202 for sensing capability information collected from neighbour communications devices of the central unit 202. This may be based on dedicated signalling for this purpose e.g. RRC signalling. During a connection setup process, or in another process following the setup process, sensors of the neighbour communications devices may report their sensing capability to the network, in other words, to the central unit 202, and this sensing capability information may be stored at the network or the central unit 202.

In addition, a neighbour communications device or a sensor thereof may be required to update the stored sensing capability information, for example by sending a transmission to the wireless communications network in order to update the sensing capability information, for example if the capability of the sensor changes. In an example, the neighbour communications device may be required to update the sensing capability information if it acquires new sensing capability information, or if the sensing capability of one or more sensors of the neighbour communications device are impaired compared to sensing capability associated with the previous sensing capability information. In this case, a requesting communications device 201 will include an indication of some information in its transmission of a sensing capability discovery request to the central unit 202, the information allowing the identification of other (neighbour) communications devices from which it requests sensing capability information. This may be in the form of location information of the communications devices of which sensing capability information is requested, a type of sensing capability information, or some other relevant identifier of communications devices.

This request may, for example, include
Location information of the communications device 201 that is requesting sensing capability. This enables the central unit 202 to send to the communications device 201 various capability information received from communications devices, sensors, that are nearby to this requesting communications device 201.
A preferred range or area in which the communications devices providing sensing capability are located. Only sensing capability related to communications devices in the preferred range or area may be sent to the requesting communications device 201.

A purpose for the request of capability information. This may enable the central unit 202 to better provide capability information to the communications device 201, and may be for example, for sensing coordination, for collaborative sensing, or another appropriate reason. The central unit 202 may be able to perform a greater proportion of processing of requesting appropriate sensing capability from other communications devices, which may have attendant benefits of reducing overall power consumption, wireless access interface interference etc.
A sensing capability requirement, e.g. based on specific sensing technology, sensing accuracy, sensing distance etc. The central unit 202 may then only send sensing capability information from sensors that conform to these requirements.

In response to receiving the sensing capability discovery request 210 the central unit 202 may transmit a sensing capability discovery response 220 as a reply message to the communications device 201. This reply message may include
Sensing capability information of the central unit 202/sensors that fulfil the requirements of the request from the communications device 201.
Synchronization information to enable the communications device 201 to determine the time at which the sensing capability information was recorded. For example, the sensing capability information may be time-stamped.
An indication related to any other conditions specified if the requesting communications device 201 determines that it wants to coordinate with the communications devices, that is, the sensors e.g. location information related to the sensors, grouping information related to the sensors etc.
Information related to identification of the neighbouring communications devices. This may take the form of providing a list of IDs for the neighbouring communications devices, such as those forming part of a group, to enable the communications device 201 to communicate with the neighbouring communications devices directly.

It should be appreciated that, in the above, as the present disclosure relates to the sharing of sensing capability information, the neighbouring communications devices are anticipated to have at least some function as sensors, and may be described as such. Therefore, the language of neighbouring communications devices may be understood to refer to the same entities as neighbouring sensors. The communications device 201 may also possess a function as a sensor, or it may operate without this function.

In some examples, the wireless communications network may configure the communications devices, sensors, when they are to send sensing capability discovery messages to the central unit or to a recipient communications device via dedicated signalling, e.g. via RRC signalling. The configurations may include
In a situation where a quality of link between the communications device, sensor, and the central unit, or between the recipient communications device and the requesting communications device exceeds a predetermined threshold e.g. a threshold number of missed sensing occasions etc.
When a sensing performance or result passes above or below a predetermined threshold e.g. a sensing accuracy is reduced beyond a threshold, a measure of braking in a vehicle exceeds a threshold acceleration value, etc.
In a broadcast or unicast mode, the network may determine and indicate to the sensor when, and in what conditions, broadcast or unicast mode may be prioritised above other modes.
In a D2D mode or central mode, the network may similarly determine and indicate to the sensor when, and in what conditions, D2D or central mode may be prioritised above other modes.

Based on the sensing capability discovery response, the communications device is able to decide with which, if any, communications device or sensor it will connect to in order to perform sharing of sensing capability and/or coordinated sensing.

In some examples, the wireless communications network may configure when the communications devices or sensors are to send sensing capability discovery messages to the central unit or to a recipient communications device, via direct Uu interface. A direct Uu interface is an interface between a user equipment, UE, and a radio access network, RAN. This means that a communications device, or UE, may send data to another UE (or group of UEs) via a base station (e.g. RSU) without the data passing through the core network, since the core network is connected to the RAN by another interface, for example the N1, N2, or N3 5G interfaces. The Uu interface was originally introduced for LTE V2X. A gNB (e.g. RSU) may configure the Uu interface to the UE in advance. For example, a gNB may configure semi-persistence scheduling (downlink) and/or configured grant (uplink). After that, the UE can request sensing capability discovery via Uu at any time. A UE (or group of UEs) may then receive the sensing capability discovery response from the gNB with minimal delay.

### Coordinated Sensing

As disused above, coordinated sending enables sensors to collaborate and exchange sensing information, with the aim to improve sensing reliability and quality. There are at least two foreseen types of coordinated sensing: sensing coordination, and collaborative sensing. Sensing coordination involves, for example, adjustment of operation or transmission parameters of a sensor to improve the sensing performance of another sensor (e.g. of another device). Collaborative sensing involves, for example, sharing data collected a sensor with another sensor or device in order to improve a sensor/device's measurement of a particular quantity (i.e. a sensing result). The present disclosure provides techniques for implementing coordinated sensing.

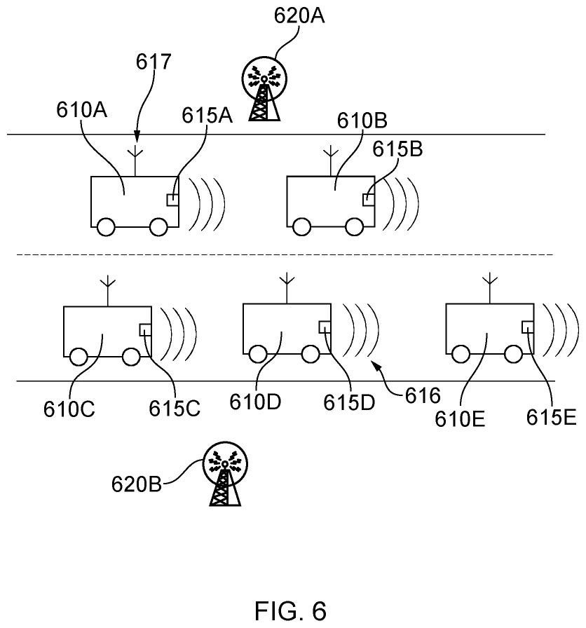

FIG. 6 shows an example of an arrangement suitable for coordinated sensing. The features of FIG. 6 are discussed in relation to the example of vehicle travelling on a road, however it should be appreciated that the techniques discussed herein are all applicable to substantially any other scenarios and arrangement. In FIG. 6, a plurality of UEs 610 are travelling on a road. Each UE 610 includes one or more sensors 615 which may perform sensing operations 616. For example, the sensors 615 may be radar sensors for detecting the distance to a preceding or following vehicle, however the sensors 615 may be substantially any other sensor. Each UE 610 may also include a transceiver 617 (i.e. a transmitter and/or receiver) for transmitting and/or receiving signals from/to a central node 620A-B and/or other UEs (i.e. other nearby UEs 610). Other vehicles may be present on the road (i.e. nearby) which do not include a transceiver 617 and/or a sensor 615A, however these have been omitted from FIG. 6 for ease of illustration.

In the example of FIG. 6, coordinated sensing could be used to improve the detection of nearby vehicles by UE 610A through communication-assisted sensing. For example, UE 610A's radar 615A may be experiencing interference from other radar 615B-E of other UEs 610B-E, or UE 610B may be too far away from UE 610A for radar 615A to accurately measure the distance to UE 610B. Accordingly, there may be a desire to improve the sensing performance of radar 615A. To achieve this, if one or more of UEs 610B-E adjust the parameters of their own radar 615B-E (for example by reducing the radar power or changing frequency), interference at radar 615A may be reduced. Similarly, if UE 610A receives location data collected from sensors 615B-E of one or more of UEs 610B-E, UE 610A may be able to use this data (for example in combination with data collected by its own sensors 615A) to more accurately determine the distance to UE 610B.

In the example of FIG. 6, coordinated sensing could be used to improve the performance of a wireless network (such as the networks shown in FIGS. 1-2) through sensing-assisted communication. For example, UE 610A may be experiencing decreases radio link quality with an infrastructure equipment (e.g. central node 620A or 620B), for example due to environmental conditions caused by the location and/or movement of UE 610A. Accordingly, there may be a desire to better account for such environmental conditions in order to improve the radio link quality of UE 610A. To achieve this, if UE 610A receives environment data collected by sensors 615B-E of nearby UEs 610B-E, UE 610A may have a better overview of the environment and may be able to take measures to more effectively manage these conditions. For example, UE 610A may be able to perform more effective or more efficient beam forming by narrowing a beam sweeping range, shortening a beam training time, or implementing better beam prediction (to name only a small number of examples) due to better knowledge of the environment.

In the present example, UE 610A is performing sensing operations 616 using sensor 615A. UE 610A may at some point identify whether a condition is met to trigger sending of a request for coordinated sensing. For example, UE 610A may determine that its sensing performance is deteriorating (e.g. by determining that a detection accuracy of sensor 615A has reduced below a predetermined threshold, that a rate or number of missed detections has increased above a predetermined threshold, or by determining that some other action indicative of a degradation in sensing performance, such as an emergency braking procedure, has been carried out by the UE). The UE 615A may identify that the sensing performance has fallen below a predetermined threshold and thus that coordinated sensing should be requested. It should be appreciated that a decline in sensing performance is only one of many possible triggers for issuing a request for coordinated sensing. For example, requests for coordinated sensing may be triggered by a measured interference level at UE 610A (e.g. an interference level for sensor 615A or transceiver 617) increasing above a predetermined threshold (which may be indicated by a measurement reporting event). In another example, requests for coordinated sensing may be triggered by a detected decrease in a radio link qualify between the UE 610A and the central node 620 or another infrastructure equipment of the wireless network.

After identifying that it should send a request for coordinated sensing, UE 610A transmits the request for other UEs to participate in coordinated sensing. This request may be transmitted in a number of possible ways. For example, UE 610A may broadcast the request for receipt by neighbouring (i.e. nearby) UEs 610B-E. This broadcast message may be based on a Device-to-Device (D2D) discovery message, or may be a newly-defined message. The request may, in some cases, include a type of coordinated sensing request by the UE 610A, such as sensing coordination or collaborative sensing. The request may additionally or alternatively indicate a reason for the coordinated sensing request, as discussed above. The request may additionally or alternatively indicate one or more requirements for participation in the coordinated sensing. For example, UE 610A may require that the sensing coordination must be among sensors of the same type (i.e. measure the same quantity, such as distance), use the same sensing technology, and/or a required sensing accuracy/precision for the sensors. The request may additionally or alternatively indicate resources (e.g. physical resources, such as a radar frequency) utilised or occupied (or scheduled to utilise/occupy) by the UE 610A. By including this information, neighbour UEs may, for example, be able to check and manage their own resource allocations in order to mitigate interference at UE 610A.

Instead of broadcasting the request as described above, UE 610A may maintain a list of sensors 615 that it has discovered and/or knows sensor capability information for. For example, UE 610A may have performed a sensor capability discovery procedure as described above to discover sensor capability information. Alternatively, UE 610A may have obtained the sensor capability information through other means or procedures. Accordingly, in such an example, UE 610A may establish a connection with UEs for which UE 610A stores sensor capability information and transmit the request after establishing this connection. The request may, for example, be based on PC5 establishment procedures or transmission to a multicast group. The request may be similar in content and layout to that described above in relation to broadcasting the request.

In other examples, UE 610A may transmit the request to a central node 620A, such as a gNB, a relay node, or a roadside unit (RSU). The central node 620A may then send the request to the UEs 610B-E (or a subset of these UEs) via unicast messages or a broadcast message. The request may be similar in content and layout to that described above in relation to broadcasting the request.

Upon receiving the request, the receiving UEs 610B-E then determine whether to participate in the coordinated sensing. This decision by the UEs 610B-E may be made based on any number of factors. For example, the decision may be based on the request from UE 610A and the contents of the request. As an example, a UE 610B-E may decide whether to participate in the coordinated sensing based on the type of sensing coordination requested, whether sensors 615B-E meet any requirements set in the request, or based on a determination by UE 610B-E as to whether UE 610B-E can aid UE 610A in achieving a desired level of performance. The decision by UEs 610B-E may also be based on one or more conditions of the UEs 610B-E. For example, a UE 610B-E may decide whether to participate in the coordinated sensing based on its own sensing capabilities/performance, load, and/or transmission parameters (e.g. transmission power and/or resource allocation), however these factors are merely examples and it should be appreciated that other factors may be utilised by UEs 610B-E when determining whether to participate in the coordinated sensing.

If a UE 610B-E, such as UE 610B, decides to participate in coordinated sensing, it transmits an indication that it will participate in the coordinated sensing. The indication may include notification of an adjustment to one or more transmissions parameters of UE 610B (for example when the request to participate in coordinated sensing is a request for sensing coordination). For example, the indication may signal that UE 610B will decrease its transmission power, or utilise different resources, or adjust one or more other transmission or sensing parameters. As just one example, UE 610B may indicate that it will reduce its sensor (radar) 615 power or change frequency for the coordinated sensing. The indication may include interference coordination information, e.g. an indication of time and/or frequency resources utilised/to be utilised by UE 610B. UE 610B may additionally or alternatively make other changes for the transmission of the indication, such as power reduction, change of the transmission timing or frequency, in order to mitigate the interference from the other UE's sensor according to the indication. The indication may alternatively or additionally include sensor data (i.e. data collected by sensor 615B) to be shared with UE 610A (for example when the request to participate in coordinated sensing is a request for collaborative sensing). A UE, such as UE 610C, that determines that it will not participate in the coordinated sensing requested by UE 610A is not required to transmit an indication that it will not participate in the coordinated sensing, however in some examples UE 610C may transmit such an indication that it will not participate in the coordinated sensing. Such an indication transmitted by UE 610C may be transmitted in the same manner as the indication transmitted by UE 610B, as discussed below.

The indication transmitted by UE 610B may take a variety of forms. For example, UE 610B may transmit the indication directly to UE 610A via a unicast message or as part of an established connection (e.g. for when UE 610A stores sensor capability information for UE 610B). UE 610B may alternatively broadcast the indication for receipt by UE 610A. In such a scenario, the indication may not only be received by UE 610A but also by one or more neighbour UEs 610C-E of UE 610B. Accordingly, neighbour UEs 610C-E may also be informed of whether UE 610B will participate in the coordinated sensing, as well as any adjustments made by UE 610B or sensor data provided by UE 610B. As such, neighbour UEs 610C-E may additionally determine whether they will participate in the coordinated sensing request by UE 610A based on the indication broadcast by UE 610B. For example, UE 610D may determine that the adjustments made by UE 610B or the sensor data provided by UE 610B are adequate (or are likely to be adequate) for meeting any requirements or desired performance levels requested by UE 610A, and thus may determine that UE 610D will not participate in the coordinated sensing (as UE 610D is not required to satisfy the request by UE 610A) in order to minimise any impact on UE 610D.

In some examples, the indication transmitted by UE 610B may be transmitted to a central node 620, such as central node 620A, or central node 620B (e.g. a gNB, relay node or RSU) that is different from central node 620A that may have received the initial request from UE 610A. The central node 620 may then forward the indication to UE 610A and may also forward the request to neighbour UEs 610C-E. Accordingly, neighbour UEs 610C-E may additionally determine whether they will participate in the coordinated sensing request by UE 610A based on the indication originating at UE 610B in the same manner as described above.

Furthermore, in some examples the decision regarding whether a UE 610B-E will participate in the coordinated sensing may be made by a central node 620. For example, central node 620 may receive an indication that UE 610E will participate in the coordinated sensing. However, central node 620 may also receive indications from one or more other UEs, such as UE 610B), that will participate in the coordinated sensing. Accordingly, before transmitting these indications to UE 610A and/or respective neighbour UEs 610B-E, central node 620 may determine which of the UEs 610B-E should participate in the coordinated sensing. For example, central node 620 may determine that adjustments to be made by UE 610B (as included in the respective indication) are adequate to satisfy the request from UE 610A. Accordingly, central node 620? may only transmit the indication from UE 610B to UE 610A, and may disregard the indication from UE 610E. The central node may then signal to UE 610E that it should not participate in the coordinated sensing.

In some examples, a UE 610B-E may be prevented from changing its decision regarding whether it will participate in the coordinated sensing too often. This may be implemented, for example, to prevent a so-called ping-pong announcement stream where UEs repeatedly change their coordination decisions based on the coordination decisions of other UEs. As such, a UE may maintain a cool down timer in which time the UE may not be allowed to change its coordination decision. Alternatively, UE may be allowed to change its coordination decision up to a predetermined number of times within a predetermined time period.

Once UE 610B has transmitted the indication that it will participate in the coordinated sensing, UE 610B may then perform any additional actions required for said participation. For example, if UE 610B has indicated that it will adjust its transmission parameters, UE 610B may then perform said adjustments to its transmission parameters. Alternatively, UE 610B may provide any additional information to UE 610A that may not have been provided in the indication that UE 610B will participate in the coordinated sensing. For example, UE 610B may in some cases not include sensor data in the indication that UE 610B will participate in the coordinated sensing, and may only transmit the sensor data later (for example via more secure means).

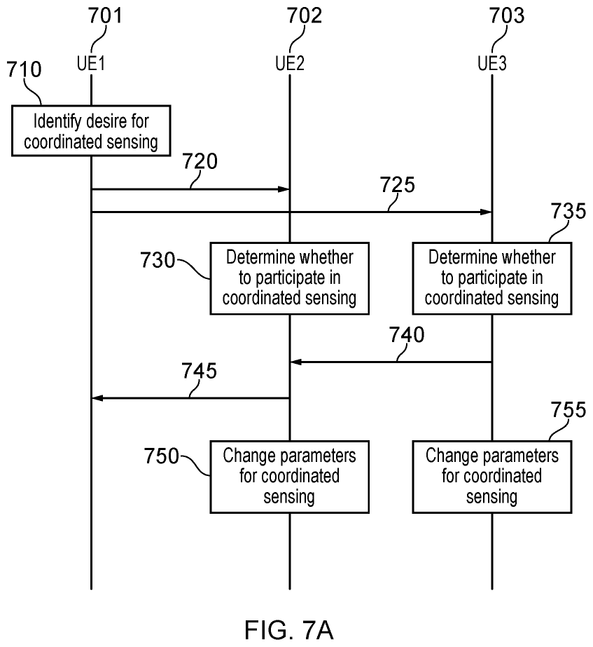

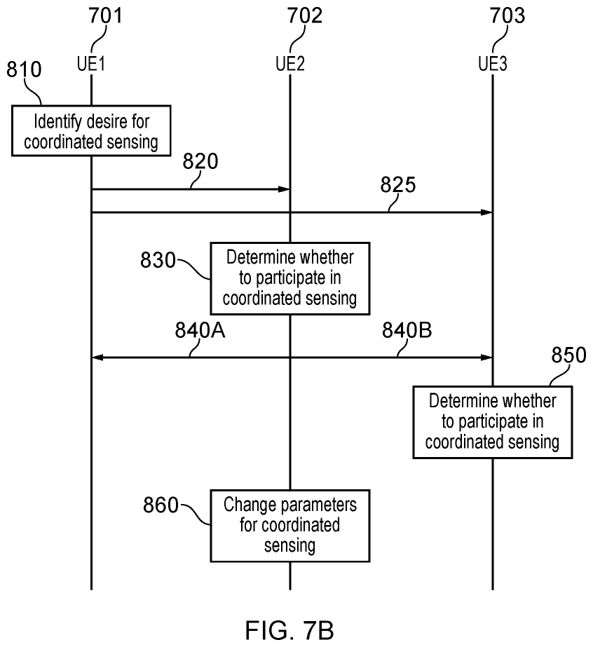

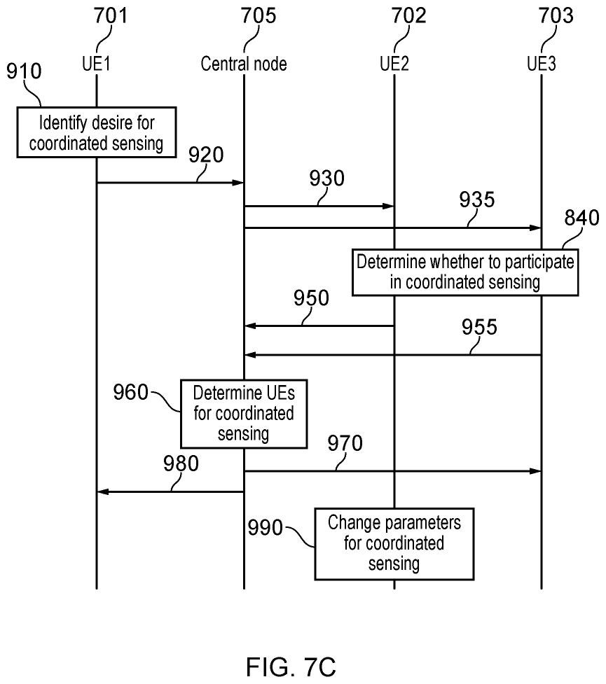

FIGS. 7A-7C illustrate example approaches for requesting coordinated sensing, as described above. In the example of FIG. 7A, UE1 701 determines that it should transmit a request for coordinated sensing (i.e. UE1 701 identifies a desire for coordinated sensing). This may, for example, be based on a deterioration in sensing performance, a measured interference level, or a decrease in radio link quality. The request may be a request for sensing coordination or collaborative sensing. UE1 701 then transmits the request 720, 725 to UE2 702 and UE3 703 respectively. The request 720, 725 may be broadcast or multicast for receipt by UE2 702 and UE3 703, or UE1 701 may establish a connection (e.g. based on a PC5 establishment procedure) with one or more of UE2 702 and UE3 703 if UE1 701 stores sensor capability information for respective ones of UE2 702 and UE3 703.

Upon receiving the requests, UE2 702 and UE3 703 determine 730, 735 whether to participate in the coordinated sensing requested by UE1 701. The determinations 730, 735 may be based on any number of factors, such as the request from UE1 701 and one or more conditions of UE2 702 and UE3 703 respectively. After determining whether to participate in the coordinated sensing, UE2 702 and/or UE3 703 may transmit indications 740, 745. For example, UE2 702 may transmit an indication 745 to UE1 701 indicating that UE2 702 will participate in the coordinated sensing. An indication (not shown) may in some cases also be sent from UE2 702 to UE3 703 (this indication may in some cases be part of a same broadcast or multicast transmission as indication 745). In addition, UE3 703 may transmit an indication 740 that it will participate in the coordinated sensing. As shown in FIG. 7A, the indication 740 may be transmitted to UE2 702 (e.g. as part of a unicast, multicast, or broadcast transmission), which may then forward (i.e. transmit) the indication 740 to UE1 701. For example, transmission 745 may include an indication of whether UE2 702 will participate in the coordinated sensing and an indication of whether UE3 703 will participate in coordinated sensing. Alternatively, UE2 702 may transmit the indication of whether UE2 702 will participate in the coordinated sensing and the indication of whether UE3 703 will participate in coordinated sensing as separate transmissions. Alternatively, in some examples UE3 703 may transmit the indication 740 directly to UE1 701 in the same manner as UE2 702.

The indications 740, 745 may in some cases include sensor data for UE2 702 and/or UE3 703. Additionally or alternatively (for example based on the type of coordinated sensing request), UE2 702 and/or UE3 703 may also indicate one or more parameters (e.g. transmission or sensing parameters) to be adjusted for the coordinated sensing. For example, the indications 740, 745 may include a notification that UE2 702 and/or UE3 703 will adjust their respective transmission parameters for the coordinated sensing. Furthermore, in the example of FIG. 7A, both UE2 702 and UE3 703 participate in the coordinated sensing and both transmit indications 740, 745 that they will participate in the coordinated sensing, however in some examples UE2 702 and/or UE3 703 may determine that they will not participate in the coordinated sensing. In such examples, UE2 702 and/or UE3 703 may or may not transmit indications that they will not participate in the coordinated sensing.

Returning to the example of FIG. 7A, after the indications 740, 745 have been transmitted by UE2 702 and UE3 703, UE2 702 and UE3 703 may take further actions 750, 755 in order to participate in the coordinated sensing. For example, UE2 702 and UE3 703 may adjust one or more parameters (i.e. transmission or sensing parameters) for the coordinated sensing (e.g. as indicated in indications 740, 745). Actions 750 and 755 may, in some cases, include transmitting sensor data to UE1 701.

FIG. 7B illustrates an alternative example of requesting and implementing coordinated sensing according to the present disclosure. The arrangement of this example includes UE1 701, UE2 702, and UE3 703 as discussed above in relation to FIG. 7B. UE1 701 identifies 810 a desire for coordinated sensing (i.e. determines to send a request for coordinated sensing) in the same manner as discussed above in relation to step 710 of FIG. 7A. UE1 701 then sends a request 820, 825 for coordinated sending to UE2 702 and UE3 702 in the same manner as requests 720, 725 discussed above in relation to FIG. 7A. UE2 702 then determines 830 whether to participate in the coordinated sensing in the same manner as the determining 730 by UE2 702 discussed above in relation to FIG. 7A.

After determining 830 that UE2 702 will participate in the coordinated sensing, UE2 702 transmits an indication 840A, 840B that it will participate in the coordinated sensing. The indication 840A may be transmitted to UE1 701 and the same indication or a separate indication 840B may also be transmitted to UE3 703. In particular, UE2 702 may broadcast a single indication 840 for receipt by UE1 701 and UE3 703, or UE2 702 may transmit separate indications 840A, 840B (e.g. via unicast or multicast transmission) to UE1 701 and UE3 703. UE3 703 may then determine 850 whether it will participate in the coordinated sensing requested by UE1 701 based on the indication 840B received from UE2 702. For example, UE3 703 may determine based on the indication 840B received from UE2 702 that it will not participate in the coordinated sensing. This may be because UE3 703 may determine that adjustments made by UE2 702 indicated in the indication 840B, or sensor data included in the indication 840B are adequate for satisfying the request for coordinated sensing. In some cases, UE3 703 may have made an initial decision regarding whether to participate in the coordinated sensing based on the request 825 (and based on the factors discussed above in relation to step 735 of FIG. 7A) and may then make a second decision regarding whether to participate in the coordinated sensing based on receiving the indication 840B from UE2 702, where UE3 703 may or may not revise or change its decision. Any such second decision may be based on the factors used in the initial decision (i.e. the factors discussed above in relation to step 735 of FIG. 7A), as well as the received indication 840B. In other cases, UE2 702 may receive or process request 825 at a later time than UE1 701 and as such may not have made any decision regarding whether to participate in the coordinated sensing before receiving the indication 840B. Accordingly, UE2 702 may make an initial decision regarding whether to participate in the coordinated sensing based on the above-discussed factors (such as those discussed above in relation to step 735 of FIG. 7A), as well as the received indication 840B.

In the present example, UE3 703 determines, based on the indication 840B, not to participate in the coordinated sensing. As such, UE3 703 does not send an indication of this non-participation to UE1 701, although UE3 703 may be configured to send a non-participation indication in some examples. UE2 702 participates in the coordinated sensing and as such may take further actions 860 in order to participate in the coordinated sensing in a similar manner to that discussed above in relation to step 750 of FIG. 7A.

FIG. 7C illustrates an alternative example of requesting and implementing coordinated sensing according to the present disclosure. The arrangement of this example includes UE1 701, UE2 702, and UE3 703 as discussed above in relation to FIG. 7B, as well as a central node 705. Central node 705 may, for example, be a gNB, relay node, or RSU in a similar manner to the central node(s) 620 of FIG. 6. UE1 701 identifies 910 a desire for coordinated sensing (i.e. determines to send a request for coordinated sensing) in the same manner as discussed above in relation to step 710 of FIG. 7A. UE1 701 then sends a request 920 for coordinated sending to the central node 705. Central node 705 sends the request 930, 935 to UE2 702 and UE3 703. In some examples, the request 920 from UE1 701 may be directed to a specific set of UEs and the central node 705 may send the requests 930, 935 only to those specific UEs. In other examples, the request 920 may not be directed to specific UEs and as such the central node 705 may either broadcast the request 930, 935 for receipt by nearby UEs, or the central node 705 may itself decide which UEs 702, 703 to send the request 930, 935 to.

UE2 702 and UE3 703 then determine 940 whether to participate in the coordinated sensing in the same manner as the determining 730, 735 by UE2 702 and UE3 703 discussed above in relation to FIG. 7A, and/or the determining 830, 850 by UE2 702 and UE3 703 discussed above in relation to FIG. 7A. In the present example, both UE2 702 and UE3 703 determine that they will participate in the coordinated sensing. As such, UE2 702 and UE3 703 transmits indications 950, 955 that they will participate in the coordinated sensing. The indications 950, 955 may be transmitted directly to central node 705 (or to a central node different from central node 705), or the indications may be transmitted via another device. For example, UE3 703 may transmit its indication 955 to UE2 702, which may then transfer the indication to the central node 705, or UE2 702 may transmit its indication 950 to UE3 703, which may then transfer the indication to the central node 705. It is further noted that in other implementations, the requests from UE1 701 may be transmitted via a central node, but the indications 950, 955 may be transmitted directly to UE1 701, or alternatively the requests from UE1 701 may be transmitted directly to the UEs 702, 703, but the indications 950, 955 may be transmitted to the central node.

Upon receiving the indications 950, 955, the central node 705 may determine 960, based on the received indications 950, 955, which of the UEs 702, 703 should participate in the coordinated sensing. For example, central node 705 may determine based on the contents of indication 950 that the data provided by UE2 702 or the actions to be taken by UE2 702 for the coordinated sensing are adequate to satisfy the request 910 from UE1 701. Accordingly, central node 705 may determine that UE2 702 should participate in the coordinated sensing but that UE3 703 should not participate in the coordinated sensing (e.g. because UE3 703 is not required to participate in order to satisfy the request 920). Accordingly, the system may minimise the number of UEs that participate in coordinated sensing in order to minimise potential disruption.

After deciding 960 that UE3 703 should not participate in the coordinated sensing, central node 705 may transmit a notification 970 to UE3 703 instructing UE3 703 not to participate in the coordinated sensing. This notification 970 may be broadcast for receipt by nearby UEs such that UE2 702 (and/or other UEs) may also be informed that UE3 703 will not be participating in the coordinated sensing. This is particularly of relevance if UE2 703 has already received an indication from UE3 703 that UE3 703 would be participating in the coordinated sharing, as UE2's 702 decision to participate in coordinated sensing may have been based on an indication received from UE3 703.

After determining 960 which UEs will participate in the coordinated sensing, the central node 705 may transmit an indication 980 of which UEs will participate in the coordinated sensing, as well as any relevant information. This indication 980 may be sent before, after, or concurrently with notification 970. The notification 970 may be sent as a unicast transmission to UE3 703, or the indication 970 may be sent as part of a broadcast transmission and may include similar notification for (specific) other UEs. The indication 980 may for example include sensor data for the participating UEs and/or adjustments to be made by the participating UEs. As UE2 702 has not received any notifications from the central node 705 instructing it not to participate in the coordinated sensing, UE2 702 may perform any adjustments needed to participate in the coordinated sensing in the same manner to steps 750 and 860 discussed above in relation to FIGS. 7A and 7B. UE2 702 may in some cases implement a timer from the transmission of indication 950 to allow time for the central node 705 to notify UE2 702 that it should not participate in the coordinated sensing, before UE2 performs the adjustments 990. That is, UE2 702 may not make the adjustments 990 before a predetermined time has elapsed from transmission of the indication 950. This prevents a UE needlessly making adjustments and needing to reverse said adjustments, thereby ensuring efficiency.

In some examples, central node 705 may transmit a modification notification (not shown in FIG. 7C) to UE2 702 indicating one or more modified adjustments for the coordinated sensing for UE2 702. For example, if UE2 702 has determined to adjust a first parameter (e.g. a transmission power), the modification notification from central node 705 may instruct UE2 702 to make a different (i.e. modified) adjustment to the first parameter (or no adjustment to the first parameter) and/or to adjustment a second parameter (e.g. a transmission frequency) which was not included in UE2's 702 originally-determined adjustments. The central node 705 may transmit this modification notification as a unicast transmission to UE2 702, or the modification notification may be sent as part of a broadcast transmission and may include similar modification notifications for (specific) other UEs. This broadcast transmission may in some examples include one or more notifications 970 for one or more UEs and one or more modification notifications for one or more UEs.

Further examples of feature combinations taught by the present disclosure are set out in the following numbered clauses:
1. A method of operating a communications device configured to transmit signals to and/or receive signals from an infrastructure equipment of a wireless communications network and/or one or more other communications devices, the method comprising:
   determining to send a request to participate in coordinated sensing to one or more other communications devices;
   transmitting the request to participate in coordinated sensing to the one or more other communications devices.
2. The method according to clause 1, wherein when participating in coordinated sensing, the communications device is configured to exchange sensor data collected by one or more sensors of the communications device with particular ones of the one or more other communications devices.
3. The method according to clause 1 or clause 2, wherein when participating in coordinated sensing, the communications device is configured to receive sensor data collected by one or more sensors of the other communications device from particular ones of the one or more other communications devices.
4. The method according to any of clauses 1-3, wherein when participating in coordinated sensing, the communications device is configured to receive sensor communication parameters for one or more sensors of the one or more other communications device.
5. The method according to any preceding clause, further comprising:
   receiving an indication that a first communications device of the one or more other communications devices will participate in coordinated sensing with the communications device.
6. The method according to clause 5, wherein the indication is received from the first communications device.
7. The method according to clause 6, further comprising:
   receiving an indication that a second communications device of the one or more other communications devices will participate in coordinated sensing with the communications device.
8. The method according to clause 5, wherein the indication is received from the infrastructure equipment.
9. The method according to any of clauses 5-8, wherein the indication identifies an adjustment to a sensing parameter by the first communications device.
10. The method according to any of clauses 5-9, wherein the indication identifies an adjustment to a communications parameter by the first communications device.
11. The method according to any of clauses 5-10, wherein the indication includes data collected by one or more sensors of the first communications device.
12. The method according to any preceding clause, further comprising:
   receiving, from a third communications device of the one or more other communications devices, an indication that the third communications device will not participate in coordinated sensing with the communications device.
13. The method according to any preceding clause, wherein the communications device determines to send the request to participate in coordinated sensing based on one or more of: a sensing performance of one or more sensors of the communications device; an interference level of one or more sensors of the communications device; and/or a radio link quality of the communications device.
14. The method according to any preceding clause, wherein the communications device transmits the request to participate in coordinated sensing to the one or more other communications devices by broadcasting the request for receipt by the one or more communications devices.
15. The method according to any preceding clause, wherein the communications device transmits the request to participate in coordinated sensing to the one or more other communications devices by transmitting a unicast or multicast request to other communications devices for which the communications device stores sensor capability information.
16. The method according to clause 15, further comprising:
   performing a sensing capability discovering procedure to determine the sensing capability information.
17. The method according to any preceding clause, wherein the communications device transmits the request to participate in coordinated sensing to the one or more other communications devices by transmitting the request to the infrastructure equipment for forwarding to the one or more other communications devices.
18. The method according to any preceding clause, further comprising:
   retransmitting the request to participate in coordinated sensing to the one or more other communications devices based on determining that a retransmission timer for the communications device has expired.
19. The method according to any preceding clause, wherein the request to participate in coordinated sensing indicates a type of coordinated sensing requested by the communications device.
20. The method according to any preceding clause, wherein the request to participate in coordinated sensing indicates a reason for transmission of the request.
21. The method according to any preceding clause, wherein the request to participate in coordinated sensing indicates one or more requirements for participation in the coordinated sensing.
22. The method according to any preceding clause, wherein the request to participate in coordinated sensing indicates one or more resources to be utilised by the communications device.
23. A communications device comprising:
   a transceiver configured to transmit signals to and/or to receive signals from an infrastructure equipment of a wireless communications network and/or one or more other communications devices, and
   a controller configured in combination with the transceiver to:
      determine to send a request to participate in coordinated sensing to one or more other communications devices;
      transmit the request to participate in coordinated sensing to the one or more other communications devices.
24. Circuitry for a communications device comprising:
   transceiver circuitry configured to transmit signals to and/or to receive signals from an infrastructure equipment of a wireless communications network and/or one or more other communications devices, and
   controller circuitry configured in combination with the transceiver to:
      determine to send a request to participate in coordinated sensing to one or more other communications devices;
      transmit the request to participate in coordinated sensing to the one or more other communications devices.
25. A method of operating a communications device configured to transmit signals to and/or receive signals from an infrastructure equipment of a wireless communications network and/or one or more other communications devices, the method comprising:
   receiving a request to participate in coordinated sensing with another communications device; and
   determining whether to participate in coordinated sensing with the other communications device.
26. The method according to clause 25, wherein the communications device determines whether to participate in the coordinated sensing based on one or more of: one or more sensing capabilities of the communications device, current transmission parameters of the communications device, a current transmission load of the communications device, and/or resources utilised by the communications device.
27. The method according to clause 25 or clause 26, wherein the communications device determines whether to participate in the coordinated sensing based on the received request.
28. The method according to any of clauses 25-27, further comprising:
   transmitting a first indication of whether the communications device will participate in the coordinated sensing with the other communications device.
29. The method according to clause 28, where communications device transmits the first indication to the other communications device.
30. The method according to clause 28 or 29, where communications device transmits the first indication to the infrastructure equipment.
31. The method according to any of clauses 28-30, wherein the communications device transmits the first indication to one or more neighbour communications devices.
32 The method according to any of clauses 28-31, wherein the communications device determines that the communications device will participate in the coordinated sensing, and wherein the first indication indicates that the communications device will participate in the coordinated sensing,
   wherein the method further comprises:
   determining an adjustment to one or more sensing parameter of the communications device, wherein the first indication identifies the adjustment to the one or more sensing parameter to be adjusted by the communications device; and
   modifying the sensing parameter according to the determined adjustment.
33. The method according to clause 32, wherein the first indication includes data collected by one or more sensors of the communications device.
34. The method according to any of clauses 25-33, further comprising:
   receiving a second indication of whether the one or more neighbour communications devices will participate in the coordinated sensing.
35. The method according to clause 34, wherein the second indication is received from the one or more neighbour communications devices.
36. The method according to clause 34 or clause 36, wherein the second indication is received from the infrastructure equipment.
37. The method according to any of clauses 34-36, wherein the second indication identifies an adjustment to one or more sensing parameters of the one or more neighbour communications devices.
38. The method according to any of clauses 34-37, wherein the determining whether to participate in the coordinated sensing is based on the second indication.
39. The method according to any of clauses 34-37, wherein the determining whether to participate in the coordinated sensing is based on one or more previous responses of the communications device to one or more previous requests to participate in coordinated sensing.
40. The method according to any of clauses 25-39, wherein the request to participate in the coordinated sensing is received from the other communications device.
41. The method according to any of clauses 25-40, wherein the request to participate in the coordinated sensing is received from the infrastructure equipment.
42. The method according to any of clauses 25-41, wherein the request to participate in the coordinated sensing is received from one or more neighbour communications devices.
43. A communications device comprising:
   a transceiver configured to transmit signals to and/or to receive signals from an infrastructure equipment of a wireless communications network and/or one or more other communications devices, and
   a controller configured in combination with the transceiver to:
      receive a request to participate in coordinated sensing with another communications device; and
      determine whether to participate in coordinated sensing with the other communications device.
44. Circuitry for a communications device comprising:
   transceiver circuitry configured to transmit signals to and/or to receive signals from an infrastructure equipment of a wireless communications network and/or one or more other communications devices, and
   controller circuitry configured in combination with the transceiver to:
      receive a request to participate in coordinated sensing with another communications device; and
      determine whether to participate in coordinated sensing with the other communications device.
45. A method of operating an infrastructure equipment configured to transmit signals to and/or receive signals from a plurality of communications devices via a wireless access interface provided by a wireless communications network, the method comprising:
   receiving, from a first communications device, a request for one or more other communications devices to participate in coordinated sensing; and
   transmitting to the one or more other communications devices, the request to participate in coordinated sensing.
46. An infrastructure equipment comprising:
   a transceiver configured to transmit signals to and/or receive signals from a plurality of communications devices, and
   a controller configured in combination with the transceiver to:
      receive, from a first communications device, a request for one or more other communications devices to participate in coordinated sensing; and
      transmit to the one or more other communications devices, the request to participate in coordinated sensing.
47. Circuitry for an infrastructure equipment comprising:
   transceiver circuitry configured to transmit signals to and/or receive signals from a plurality of communications devices, and
   controller circuitry configured in combination with the transceiver to:
      receive, from a first communications device, a request for one or more other communications devices to participate in coordinated sensing; and
      transmit to the one or more other communications devices, the request to participate in coordinated sensing.
48. A method of operating an infrastructure equipment configured to transmit signals to and/or receive signals from a plurality of communications devices via a wireless access interface provided by a wireless communications network, the method comprising:
   receiving a first indication that a first communications device will participate in coordinated sensing requested by a second communications device; and
   transmitting to the second communications device, the first indication.
49. The method according to clause 48, further comprising:
   receiving a second indication that a third communications device will participate in the coordinated sensing requested by a second communications device;
   determining, based on receiving the first indication, not to transmit, to the second communications device, an indication that the third communications device will participate in the coordinated sensing.
50. The method according to clause 49, further comprising:
   transmitting an instruction to the third communications device not to participate in the coordinated sensing.
51. The method according to clause 50, further comprising:
   receiving a third indication that a fourth communications device will participate in the coordinated sensing requested by a second communications device;
   determining, based on receiving the first indication, not to transmit, to the second communications device, an indication that the fourth communications device will participate in the coordinated sensing; and
   broadcasting a transmission including the instruction to the third communications device not to participate in the coordinated sensing and an instruction to a fourth communication device not to participate in the coordinated sensing.
52. The method according to any of clauses 48-51, further comprising:
   identifying, based on the first indication, one or more first adjustments to be made to one or more parameters of the first communications device;
   determining one or more second adjustments to the one or more parameters;
   transmitting an instruction to the first communications device to adjust the one or more parameters according to the one or more second adjustments; and
   transmitting the one or more second adjustments to the second communications device.
53. The method according to any of clauses 48-52, further comprising:
   based on receiving the first indication, transmitting, to a fifth communications device, an instruction not to participate in the coordinated sensing.
54. An infrastructure equipment comprising:
   a transceiver configured to transmit signals to and/or receive signals from a plurality of communications devices, and
   a controller configured in combination with the transceiver to:
      receive a first indication that a first communications device will participate in coordinated sensing requested by a second communications device; and
      transmit to the second communications device, the first indication.
55. Circuitry for an infrastructure equipment comprising:
   transceiver circuitry configured to transmit signals to and/or receive signals from a plurality of communications devices, and
   controller circuitry configured in combination with the transceiver to:
      receive a first indication that a first communications device will participate in coordinated sensing requested by a second communications device; and
      transmit to the second communications device, the first indication.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] S1-220191, “Study on Integrated Sensing and Communication”, 3^{rd} Generation Partnership Project, February 2022
[4] S1-221091, “Coordinated Sensing Operations”, 3^{rd} Generation Partnership Project, May 2022

1. A method of operating a communications device configured to transmit signals to and/or receive signals from an infrastructure equipment of a wireless communications network and/or one or more other communications devices, the method comprising:
determining to send a request to participate in coordinated sensing to one or more other communications devices;
transmitting the request to participate in coordinated sensing to the one or more other communications devices.

2. The method according to claim 1, wherein when participating in coordinated sensing, the communications device is configured to exchange sensor data collected by one or more sensors of the communications device with particular ones of the one or more other communications devices.

3. The method according to claim 1, wherein when participating in coordinated sensing, the communications device is configured to receive sensor data collected by one or more sensors of the other communications device from particular ones of the one or more other communications devices.

4. The method according to claim 1, wherein when participating in coordinated sensing, the communications device is configured to receive sensor communication parameters for one or more sensors of the one or more other communications device.

5. The method according to claim 1, further comprising:
receiving an indication that a first communications device of the one or more other communications devices will participate in coordinated sensing with the communications device.

6. The method according to claim 5, wherein the indication is received from the first communications device.

7. The method according to claim 6, further comprising:
receiving an indication that a second communications device of the one or more other communications devices will participate in coordinated sensing with the communications device.

8. The method according to claim 5, wherein the indication is received from the infrastructure equipment.

9. The method according to claim 5, wherein the indication identifies an adjustment to a sensing parameter by the first communications device.

10. The method according to claim 5, wherein the indication identifies an adjustment to a communications parameter by the first communications device.

11. The method according to claim 5, wherein the indication includes data collected by one or more sensors of the first communications device.

12. (canceled)

13. The method according to claim 1, wherein the communications device determines to send the request to participate in coordinated sensing based on one or more of: a sensing performance of one or more sensors of the communications device; an interference level of one or more sensors of the communications device; and/or a radio link quality of the communications device.

14.-24. (canceled)

25. A method of operating a communications device configured to transmit signals to and/or receive signals from an infrastructure equipment of a wireless communications network and/or one or more other communications devices, the method comprising:
receiving a request to participate in coordinated sensing with another communications device; and
determining whether to participate in coordinated sensing with the other communications device.

26. The method according to claim 25, wherein the communications device determines whether to participate in the coordinated sensing based on one or more of: one or more sensing capabilities of the communications device, current transmission parameters of the communications device, a current transmission load of the communications device, and/or resources utilised by the communications device.

27. The method according to claim 25, wherein the communications device determines whether to participate in the coordinated sensing based on the received request.

28. The method according to claim 25, further comprising:
transmitting a first indication of whether the communications device will participate in the coordinated sensing with the other communications device.

29. The method according to claim 28, where communications device transmits the first indication to the other communications device.

30. The method according to claim 28, where communications device transmits the first indication to the infrastructure equipment.

31. (canceled)

32. The method according to claim 28, wherein the communications device determines that the communications device will participate in the coordinated sensing, and wherein the first indication indicates that the communications device will participate in the coordinated sensing, and wherein the method further comprises:
determining an adjustment to one or more sensing parameter of the communications device, wherein the first indication identifies the adjustment to the one or more sensing parameter to be adjusted by the communications device; and
modifying the sensing parameter according to the determined adjustment.

33.-45. (canceled)

46. An infrastructure equipment comprising:
a transceiver configured to transmit signals to and/or receive signals from a plurality of communications devices, and
a controller configured in combination with the transceiver to:
receive, from a first communications device, a request for one or more other communications devices to participate in coordinated sensing; and
transmit to the one or more other communications devices, the request to participate in coordinated sensing.

47.-55. (canceled)
